(19) United States
(12) Patent Application Publication
(10) Pub. No.: US 2014/0046492 A1
(43) Pub. Date: Feb. 13, 2014

(54) Method and Apparatus for Providing Drug Infusion Values to an Infusion Pump

(71) Applicant: EBroselow, LLC, Blacksburg, VA (US)

(72) Inventor: James Broselow, Hickory, NC (US)

(73) Assignee: EBroselow, LLC, Blacksburg, VA (US)

(21) Appl. No.: 14/059,850

(22) Filed: Oct. 22, 2013

Related U.S. Application Data
(63) Continuation-in-part of application No. 13/904,725, filed on May 29, 2013.
Application No. 13/904,725 is a continuation-in-part of application No. 13/175,668, filed on Jul. 1, 2011, now Pat. No. 8,494,875.
Application No. 13/175,668 is a continuation-in-part of application No. 12/203,218, filed on Sep. 3, 2008, now abandoned.

(51) Int. Cl. G06F 19/00

(52) U.S. Cl. CPC G06F 19/3468
USPC 700/283

(57) ABSTRACT

A computerized method and related apparatus for providing drug infusion values to an infusion pump. A computer database is provided containing a plurality of predetermined drugs, precalculated indication-specific treatment dosages and precalculated infusion rates based on the weight or weight range of a patient to be infused with the drug. An input device in communication with the computer database is provided for inputting the patient's weight, and the drug to be administered. An electronic display communicates with the computer database for displaying a coded image representing a drug infusion rate for the drug to be administered based on the patient's weight. A drug infusion pump is provided and adapted for accepting a digital data input representing a drug infusion rate to be administered to the patient automatically in real time and for adjusting the drug infusion rate to correspond to the digital data input.

### CROSS-REFERENCE TO RELATED APPLICATIONS

This application is a continuation-in-part application which claims priority to U.S. patent application Ser. No. 13/904,725 filed May 29, 2013, which claims priority to U.S. patent application Ser. No. 13/175,668 filed Jul. 1, 2011 which claims priority to U.S. patent application Ser. No. 12/203,218 filed Sep. 3, 2008, the contents of which are incorporated by reference herein.

### TECHNICAL FIELD AND BACKGROUND OF THE INVENTION

This application relates to administration of drugs, and more specifically to the administration of drugs by infusion, particularly in a hospital or emergency setting where under present practices errors in administration are most likely to occur.

Since the Institute of Medicine Report “To Err is Human” was published in 1999, there has been a widespread and profound movement to eliminate medical errors. One of the principal areas of focus is medication safety with a specific concern related to IV drug administration. Because IV medications are generally delivered in more critical circumstances and to a generally more vulnerable patient population, the need for speed, efficacy and safety must all be addressed. In general, safe medication administration is intended to be guided and controlled by the “5 Rights”—right patient, right medication, right dose, right route, and right time. Ideally, automated systems should be in place that have access to all relevant clinical, patient, and medication-specific parameters every time an IV medication is administered to a patient. Included should be the medication name and final concentration, dose, route and time of administration as well as any medication allergies. In fact, multiple systems have been developed utilizing various combinations of access to computerized patient records, electronic Medication Administration Records (eMar), patient identification tagging, enterprise software, mobile computer software, and “Smart Infusion Pumps” with extensive internal programmable libraries. U.S. Pat. Nos. 6,269,340; 5,681,285; 8,149,131; 7,471,994 and European Patent No. 813428 exemplify aspects of these systems.

Once all of the relevant information is stored in the infusion pump and is retrievable, various combinations of computers and handheld devices are utilized to process the data prior to medication administration at the bedside.

With all of these comprehensive solutions, medications, patients, electronic patient records and infusion devices must all communicate with each other utilizing WiFi systems, bar coding, and RFID and/or infrared devices to permit communication in such a way as to permit the system to function as intended. Although it is clearly optimal to have an automated, fail-safe system in place, there are clearly times when this is not feasible. Without real time access to a comprehensive database, correctly programming an infusion device becomes quite problematic. The mathematics involved is extremely difficult and has to include the drug dose, concentration, and specific indication as well as drug specific therapeutic ranges which frequently vary as a function of the patient's weight.

As an example, acute medications that raise or lower blood pressures (“vasoactive medications”) are frequently ordered in micrograms per kilogram of weight per minute, yet frequently the infusion pumps must be set to administer the medication in milliliters per hour. Errors can easily occur both initially when setting up the equations as well as when calculating the results. Errors may also occur concurrently as the parameters are set. With these demands, even in the best of circumstances errors occur. However, the best of circumstances are usually not present when treating a critically ill patient. In fact, when a nurse under stress is treating a critically ill patient, it is virtually impossible to perform these calculations quickly and safely every time.

Although currently used devices may sound an alert if a programmed setting is not within its dosing parameter for that particular drug library, these alerts are non-specific and require the nurse to repeat the entire calculation or all programming steps. If the repeated calculation seems correct, it is still required to make certain that the alert is actually relevant to the particular patient situation at hand. If it still appears that a manual override may be needed, a second nurse may be summoned to check the calculation, the library accessed and proper indication prior to drug administration, all of which results in further delays in the proper delivery of needed care to the patient. Clearly, there is a need for an automated system to correctly set an infusion pump accurately and rapidly in all clinical settings regardless of whether external support systems being in place and available for use at the required time.

The present systems utilizing infusion pumps with built-in digital libraries have clearly helped reduce dosing errors related to medication infusion delivery, but still have many practical shortcomings. For instance, there are different digital drug libraries for the same medications depending on where they are being delivered. On the medical floor, the upper drug dosages are more limited than in intensive care units where more available nursing is required to monitor the medication's effects and safety. Or, more concentrated solutions may be needed in an intensive care unit to avoid fluid overload where multiple infusions may be running simultaneously. Concentrations utilized in the operating room may not be appropriate in intensive care units, nurseries and the like. In fact, it is not at all uncommon for medications on infusion pumps to be discarded, and the pump reprogrammed when a patient goes from one area of the hospital to another, such as when a patient is transferred from one medical institution to another. Each new pump must have a library that accommodates that particular medication, concentration and indication.

Because of the complexities within the present solutions, delays are commonplace as well. Since each pump may contain multiple libraries, it may take substantial precious time for a nurse to scroll down a long list to find the correct library for that particular drug and clinical circumstance. Similarly, when a pump that is normally utilized in a particular clinical area such as the operating room, intensive care unit or nursery is in a different location, it may not have the library programmed for the particular need at hand. Also, the skill and ease with which a given nurse can access this information clearly varies according to a nurse's experience and working environment. An intensive care unit nurse, for instance, may be very familiar with all of the libraries in the intensive care unit pumps, whereas a recovery room nurse may have to suddenly and with little advance notice administer a lifesaving intravenous drip but may have had very little training or experience on navigating the pump's libraries or may not even know that the pump has libraries. However, the most common source of delay is the requirement that the correct library be accessed prior to infusing the medication. This introduces a level of complexity that necessitates significant training for a nurse to perform that procedure properly. In fact, there are hospitals that have special teams that are sent from the pharmacy to set the pumps in an effort to avoid errors occurring, even with the libraries in place.

A good example of the complexity is the fact that doctors normally do not know how to set an infusion pump for their own orders. It would certainly be simpler and clearly safer if a physician could determine an infusion order on a mobile device, for example, and then automatically set the pump directly from the device. Certainly this process assures the 5 rights noted above, since both the ordering physician and the patient are actually together as the process is initiated and carried out.

In addition to the difficulties using the prior art infusion systems at the bedside noted above, the process of developing and updating clinical libraries is itself complex, with significant demands on time, manpower and money. New drugs, doses and indications occur for the whole spectrum of patients from neonates, pediatrics and adults. This frequently requires that a committee approve new guidelines, develop new libraries and then update all of the appropriate pumps. A large hospital system may have 500 pumps that need to be updated, either manually or by enterprise software WiFi solutions. Even this process can occasionally be unreliable, for instance, if the programming occurs when a pump is off line or does not have an active power source. In addition, there are times when complex drugs must be administered manually when there is no matching library available. For example, there may be instances where a patient is receiving a rare chemotherapy infusion that may be standard, but so infrequent that the resources necessary to put in an additional library just for that particular drug is prohibitive. This is even more complex when a patient is on a research protocol and thus is to receive a dose that is not normally given, but is appropriate for this particular patient's needs. Certainly, no “library” would be programmed into a pump just for a single patient.

The present solutions require expensive equipment together with significant resources and time. These present solutions are therefore more appropriate for large successful hospitals with ample in-house expertise, resources and budgets to support them. And even these systems may occasionally need “backups” in areas of the hospital where WIFI systems may be overloaded and not functioning at different times or in different areas of the hospital.

But infusions are also needed in small facilities such as critical access hospitals, infusion centers or nursing homes. Elaborate and expensive solutions such as those used in large hospitals are simply not practical or affordable in these other important areas of care. There is clearly a need for a simpler, less expensive solution that works both in large and small hospitals, at a bedside computer or when a patient is mobile, in elective as well as emergency situations. Likewise, it is also important to remove the need for “alerts” and libraries because the drug dosing itself is automated and correct in the first place. Also, such a system should not require that a WiFi network be available so that such as system would work in the back of an ambulance or in a helicopter.

The solution is that for any specific drug, patient weight, indication concentration, dilution, and rate of administration, a code is translated into the universal language of all infusion pumps, output per unit time, generated and important information made available and operative in real time. By real time is meant the actual time during which a process takes place or an event occurs, and when computer applications or processes are able to respond immediately to user input.

This drug and process specific code is then displayed on a mobile screen to be captured by a pump input such as a camera or scanner directly, or transferred from any computerized system onto the drug label allowing the label to be scanned, captured by photo or sent by RFID or infrared directly to the pump, at which time the pump is set to the correct infusion setting. A standard bar code or the more recent Quick Response (“QR”) code can be created specific to the particular infusion administration, or printed onto a label for attachment to an infusion bag, patient record or otherwise as needed.

The coded label is used to communicate to the infusion pump the appropriate mLs per minute or per hour needed to deliver that particular drug, concentration, indication and range safely, accurately and appropriately to the patient. The label itself is generated by a PC, mobile computer, smart phone or tablet into which has been inputted all of the relevant dosing parameters, including the patient's weight, dose, indication, dosing ranges and concentrations. The device can process the information, codify the process, and then utilize that code to directly set the infusion pump. Thus, an infusion pump containing complementary software can read the code and instantly and independently set the pump correctly for any drug, weight range, concentration, or indication. There is no need for “libraries” or special intermediary mobile devices. In addition, there is no need for extensive educational processes needed to teach each potential user of present systems how the libraries work, or what the correct procedure is when an infusion pump provides an alert. There is no need for committees to build the libraries, update them, or download them into the pumps. With a single bedside scan or image capture, each pump is automatically and instantly set by the exact medication recipe generated specifically for that patient and indication. It has the capability to function for common as well as rare medications, and will save hospitals time, money, and resources while reducing medication errors throughout the continuum of care. The novel system disclosed in this application is particularly suitable for use in emergency situations or in remote locations where specialized information may not otherwise be available.

### SUMMARY OF THE INVENTION

It is therefore an object of the invention to provide for a simpler, less expensive infusion pump system and solution that works both in large and small hospitals, at a bedside computer or when a patient is mobile, in elective as well as emergency situations.

It is another object to provide a system that utilizes a unique medication process code to communicate the appropriate dosage to an infusion device for administration to a patient.

It is another object to provide a system that does not require electronic access to the patient or to the patient's electronic medical record.

It is a further object of the invention to remove the need for “alerts” and libraries by providing a system wherein the drug dosing itself is automated and correct in the first instance.

It is a further object of the invention to provide a system that does not require that a WiFi network be available in order that the system that the system will work in an emergency vehicle such as an ambulance or in a helicopter.

It is a further object of the invention to provide a system that, for any specific drug, patient weight, indication concentration, dilution, and rate of administration, a code is translated into the universal language of all infusion pumps, which generates a value based on output per unit of time.

It is a further object of the invention to provide a system that functions independently of patient-specific information except for approximate body weight.

It is a further object of the invention to provide a system where there is no need for infusion specific drug libraries, manual programming of the pump, or special intermediary mobile devices.

It is a further object of the invention to provide a system where there is no need for extensive educational processes to teach each potential user of present systems how the libraries work, or what the procedure is when an infusion pump provides an alert.

It is a further object of the invention to provide a system in which there is no need for infusion pump drug libraries, no need to update them, or need to download them into the pumps.

It is a further object of the invention to provide a system that operates with a single bedside scan or image capture, and wherein each pump is automatically and instantly set by the exact medication recipe generated specifically for that patient and indication.

These and other objects and advantages of the invention are achieved by providing a computerized method for providing drug infusion values to an infusion pump that includes the steps of providing a computer database having a plurality of predetermined drugs, precalculated indication specific treatment dosages and precalculated infusion rates based on the weight or weight range of a patient to be infused with the drug. An input device that can communicate with the computer database is provided for inputting the patient's weight, and the drug to be administered. An electronic display is provided in communication with the computer database for displaying a coded image representing a drug infusion rate for the drug to be administered based on the patient's weight. A drug infusion pump is adapted for accepting a digital data input representing a drug infusion rate to be administered to the patient automatically in real time and for adjusting the drug infusion rate to correspond to the digital data input. The drug infusion rate for the drug to be administered is input into the infusion pump based on the patient's weight corresponding to the scanned coded image to the drug infusion pump. The infusion pump is set automatically in real time to infuse the drug at the drug infusion rate transmitted to the infusion pump. The drug is then infused into the patient at the drug infusion rate transmitted to the infusion pump.

According to another embodiment of the invention, the method includes the step of scanning the coded image at the time of drug infusion.

According to another embodiment of the invention, the method the drug infusion rate for the drug to be administered is transmitted directly from the electronic display of the database to the drug infusion pump.

According to another embodiment of the invention, the method includes the steps of transmitting the drug infusion rate for the drug to be administered from the electronic display of the database to a printer, printing a label containing a coded image representing a drug infusion rate for the drug to be administered based on the patient's weight, applying the label to a container of the drug to be infused, scanning the label at the time of infusion, setting the infusion pump automatically in real time in response to the information on the scanned label, and infusing the drug into the patient at the drug infusion rate transmitted to the infusion pump.

According to another embodiment of the invention, the step of scanning the coded image occurs at a place remote from the patient and at a time prior to the time of drug infusion.

According to another embodiment of the invention, an apparatus is adapted for providing drug infusion values to an infusion pump, and includes a computer database having a plurality of predetermined drugs, precalculated indication specific treatment dosages and precalculated infusion rates based on the weight or weight range of a patient to be infused with the drug, an input device for communicating with the computer database for inputting the patient's weight, and the drug to be administered, and an electronic display in communication with the computer database for displaying a coded image representing a drug infusion rate for the drug to be administered based on the patient's weight. A drug infusion pump is adapted for accepting a digital data input representing a drug infusion rate to be administered to the patient automatically in real time and for adjusting the drug infusion rate to correspond to the digital data input. A scanner is provided for transmitting the drug infusion rate for the drug to be administered based on the patient's weight corresponding to the scanned coded image to the drug infusion pump. The infusion pump is adapted to automatically in real time infuse the drug at the drug infusion rate transmitted to the infusion pump.

According to another embodiment of the invention, the scanner is adapted for scanning the coded image at the time of drug infusion.

According to another embodiment of the invention, the scanner is adapted for scanning the drug infusion rate for the drug to be administered and transmitting the digital data representing the drug infusion rate directly from the electronic display of the database to the drug infusion pump.

According to another embodiment of the invention, a printer is provided for receiving digital data representing the drug infusion rate for the drug to be administered from the electronic display of the database and printing a label containing a coded image representing a drug infusion rate for the drug to be administered based on the patient's weight for application to a container of the drug to be infused.

According to another embodiment of the invention, the infusion pump is devoid of a digital storage medium for storing information relating to drugs and drug dosages except for digital data representing a drug and drug infusion rate transmitted to the infusion pump at the time of infusion.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a screen shot of a screen utilized to determine a correct dosage of a specific drug for a patient of a given weight range; and

FIG. 2 is a flow diagram of an infusion system according to a preferred embodiment of the invention.

### DESCRIPTION OF THE PREFERRED EMBODIMENT AND BEST MODE

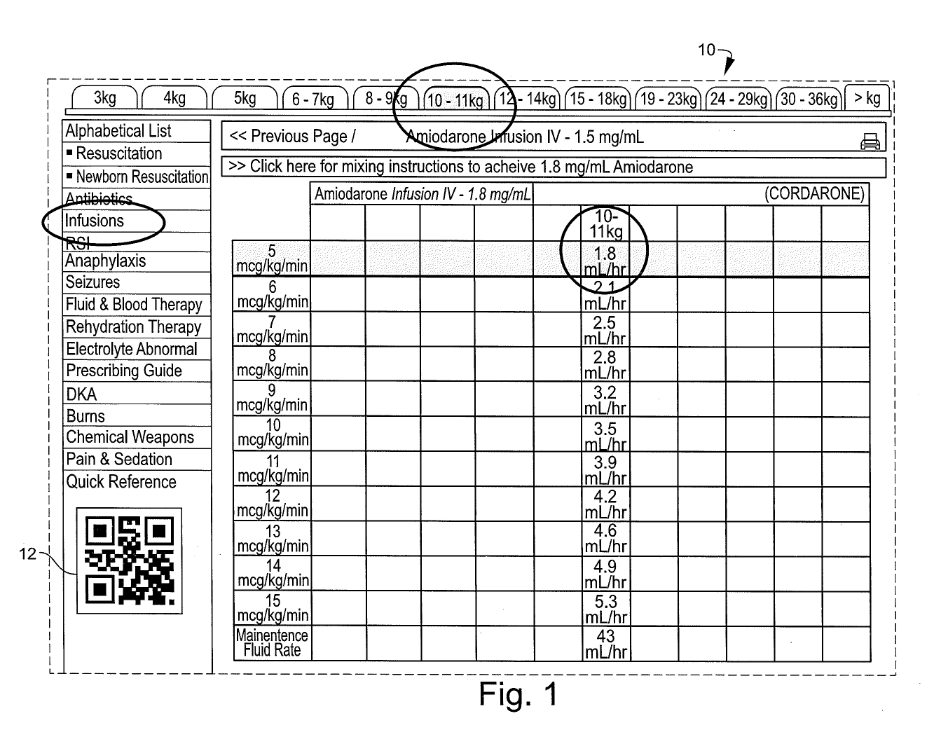

Referring now specifically to the drawings, a screen shot of a drug dosage computer program display page 10 is shown in FIG. 1. The display returns data previously programmed into a database, such as, for example, described in applicant's U.S. Pat. No. 8,494,875. In a given situation, a physician determines from a patient's condition and medical needs a drug for administration by infusion via an infusion pump. It is important to note that it is not necessary that the physician have access to medical records or patient information other than an estimate of the patient's weight. By selecting the correct patient weight range, the software instantly returns a drug infusion dosage from the information programmed in the database.

As also shown in FIG. 1, the treatment type, “infusion”, is selected from a menu of available treatment options, shown extending down the left-hand side of the menu on page 10, then the desired drug, for example, Amiodarone IV is selected from a drop down menu that extends across the top of the page 10, also as shown. By selecting the appropriate patient weight range, for example, 10-11 kgs, from the weight range tabs across the top of the page 10, the correct infusion pump setting-1.8 mL/hr is shown. The dosage is also shown in the correct equivalent dosage of 5 mcg/kg/min. At the same time, a visual code, such as the QR code 12 shown in the lower left corner of page 10, is generated that contains the information necessary to automatically set an infusion pump to administer the required drug according to the required dosage—1.8 mL/hr.

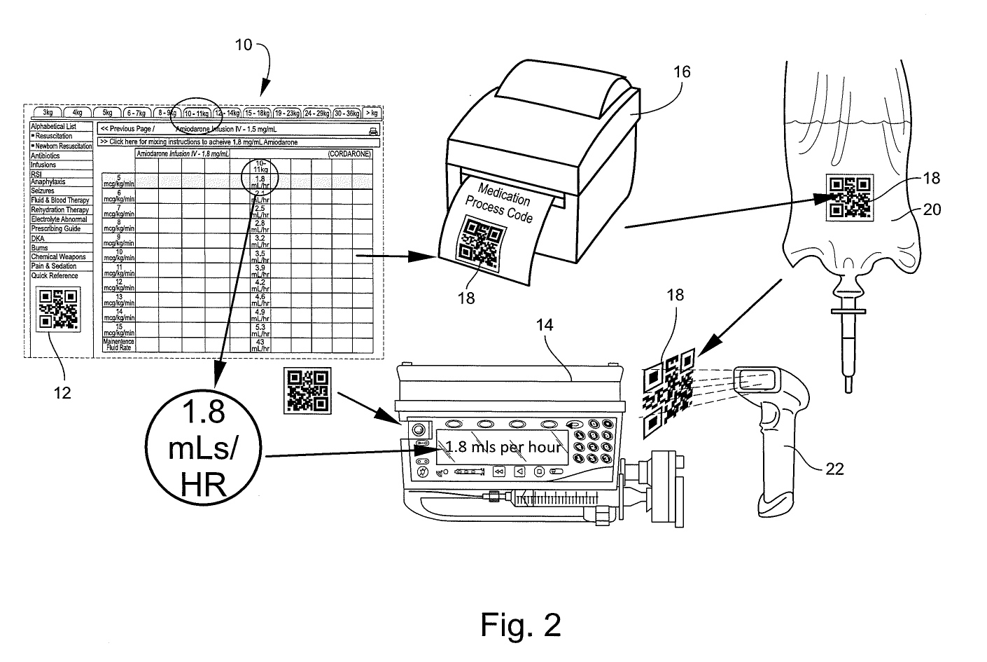

As shown in FIG. 2, this information may be used in different ways. First, the QR code 12 can be scanned from the page 10 and the digital information detected sent directly to the infusion pump 14, which is then automatically programmed to infuse the drug at a rate of 1.8 mL/hr.

Alternatively, scanning the QR code 12 can be programmed to cause a printer 16 to print the same or equivalent QR code onto a label 18 which is then applied to an infusion bag 20. In this situation, as might occur when the infusion is being prepared in a hospital pharmacy or in some other location remote from the pump 14 and patient, the bag 20 is delivered to the bedside, where the label 18 on the bag 20 is scanned, for example by a scanner 22 and the infusion pump 14 is set to deliver the drug at the proper infusion rate. In both instances, no calculations are required. No “library” of information is required to be present in the infusion pump 14. The information is made available from an accessible website to, for example, a PC, iPad, iPhone or other device either by wire or wirelessly. A single website can be maintained in an up-to-date manner and made available to many thousands of infusion pumps, such as infusion pump 14, without further programming or drug information data entry. The only data entry required at the time of administration or preparation is the physician's drug selection based on the diagnosis and the estimated weight of the patient.

A method for providing drug infusion values to an infusion pump and related apparatus is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A computerized method for providing drug infusion values to an infusion pump, comprising the steps of:
(a) providing a computer database having a plurality of predetermined drugs, precalculated indication specific treatment dosages and precalculated infusion rates based on the weight or weight range of a patient to be infused with the drug;
(b) providing an input device in communication with the computer database for inputting the patient's weight, and the drug to be administered;
(c) providing an electronic display in communication with the computer database for displaying a coded image representing a drug infusion rate for the drug to be administered based on the patient's weight;
(d) providing a drug infusion pump adapted for accepting a digital data input representing a drug infusion rate to be administered to the patient automatically in real time and for adjusting the drug infusion rate to correspond to the digital data input;
(e) transmitting the drug infusion rate for the drug to be administered based on the patient's weight corresponding to the scanned coded image to the drug infusion pump;
(f) setting the infusion pump automatically in real time to infuse the drug at the drug infusion rate transmitted to the infusion pump; and
(g) infusing the drug into the patient at the drug infusion rate transmitted to the infusion pump.

2. A method according to claim 1, and including the step of scanning the coded image at the time of drug infusion.

3. A method according to claim 1, wherein the drug infusion rate for the drug to be administered is transmitted directly from the electronic display of the database to the drug infusion pump.

4. A method according to claim 1, wherein the method includes the steps of:
(a) transmitting the drug infusion rate for the drug to be administered from the electronic display of the database to a printer;
(b) printing a label containing a coded image representing a drug infusion rate for the drug to be administered based on the patient's weight;
(c) applying the label to a container of the drug to be infused;
(d) scanning the label at the time of infusion;
(e) setting the infusion pump automatically in real time in response to the information on the scanned label; and
(f) infusing the drug into the patient at the drug infusion rate transmitted to the infusion pump.

5. A method according to claim 1, and including the step of scanning the coded image at a place remote from the patient and at a time prior to the time of drug infusion.

6. An apparatus for providing drug infusion values to an infusion pump, comprising:
(a) a computer database having a plurality of predetermined drugs, precalculated indication specific treatment dosages and precalculated infusion rates based on the weight or weight range of a patient to be infused with the drug;
(b) an input device for communicating with the computer database for inputting the patient's weight, and the drug to be administered;
(c) an electronic display in communication with the computer database for displaying a coded image representing a drug infusion rate for the drug to be administered based on the patient's weight;
(d) a drug infusion pump adapted for accepting a digital data input representing a drug infusion rate to be administered to the patient automatically in real time and for adjusting the drug infusion rate to correspond to the digital data input;
(e) a scanner for transmitting the drug infusion rate for the drug to be administered based on the patient's weight corresponding to the scanned coded image to the drug infusion pump; and
(f) the infusion pump adapted to automatically in real time infuse the drug at the drug infusion rate transmitted to the infusion pump.

7. An apparatus according to claim 6, wherein the scanner is adapted for scanning the coded image at the time of drug infusion.

8. An apparatus according to claim 6, wherein the scanner is adapted for scanning the drug infusion rate for the drug to be administered and transmitting the digital data representing the drug infusion rate directly from the electronic display of the database to the drug infusion pump.

9. An apparatus according to claim 6, and including a printer for receiving digital data representing the drug infusion rate for the drug to be administered from the electronic display of the database and printing a label containing a coded image representing a drug infusion rate for the drug to be administered based on the patient's weight for application to a container of the drug to be infused.

10. An apparatus according to claim 6, wherein the infusion pump is devoid of a digital storage medium for storing information relating to drugs and drug dosages except for digital data representing a drug and drug infusion rate transmitted to the infusion pump at the time of infusion.
